(19) United States
(12) Patent Application Publication
(10) Pub. No.: US 2022/0390633 A1
(43) Pub. Date: Dec. 8, 2022

(54) FAST, DEEP LEARNING BASED, EVALUATION OF PHYSICAL PARAMETERS IN THE SUBSURFACE

(71) Applicant: BELMONT TECHNOLOGY INC., Katy, TX (US)

(72) Inventors: JEAN-MARIE LAIGLE, Houston, TX (US); JACK STALNAKER, Houston, TX (US)

(21) Appl. No.: 17/775,805

(22) PCT Filed: Nov. 19, 2020
(86) PCT No.: PCT/US2020/061150

§ 371 Date: May 10, 2022

Related U.S. Application Data
(60) Provisional application No. 62/937,465, filed on Nov. 19, 2019.

(51) Int. Cl. G01V 1/28; G06N 20/00

(52) U.S. Cl. CPC G01V 1/282; G06N 20/00

(57) ABSTRACT

A method includes, in a computer, generating a discretized model of the subsurface formation in space and time. The discretized model comprises at least one physical parameter of the formation and a relationship between the physical parameter and the physical property. For each spatial location and at each time in the discretized model, a time independent solution to the relationship is calculated. A context is defined of a selected number of grid cells surrounding each spatial location. Dimensionality reduction is performed on each context. Each dimensionality reduced context is input into the computer as a separate earth model to train a machine learning system to determine a relationship between the dimensionality reduced context and the physical property. The trained machine learning system is used to estimate the physical property at each spatial location and at each time.

### BACKGROUND

This disclosure relates to the field of simulation of physical phenomena, which simulation may be used to predict characteristics of a physical system prior to implementation. More specifically, the disclosure relates to methods for simulating the physical state of subsurface geological formations, its fluid content and fluid production and including parameters such as pore pressure, porosity, effective stress and lithostatic stress.

Modeling or simulating a physical phenomenon, for example, pressure in a subsurface geologic fluid reservoir may be performed by solving the governing partial differential equations (PDE). Modeling traditionally involves solving these PDEs either analytically or numerically using an approach such as the finite element method or the finite volume method. Analytical solutions are fast, but are typically limited to very simple, unrealistic models. Numerical solutions are generic but are typically slow and require significant computational resources.

Modeling known in the art maps a set of physical parameters to a set of simulated observations. Alternatively, it is known to use a neural network approach to solve the governing PDEs. Neural networks “learn” the mapping (called being “trained”) from physical parameters to observations, replicating the action of the PDEs without explicitly solving them. Physics-based neural network solutions drive the neural network with some constraints derived from the governing physics.

### SUMMARY

One aspect of the present disclosure is a method for simulating or estimating a physical property of a subsurface formation. A method according to this aspect includes, in a programmable computer, generating a discretized model of the subsurface formation in space and time. The discretized model comprises at least one physical parameter of the subsurface formation and a relationship between the at least one physical parameter and the physical property. In the computer, for each spatial location and at each time in the discretized model, a time independent solution to the relationship is calculated. In the computer, a context is defined of a selected number of grid cells surrounding each spatial location; In the computer, dimensionality reduction is performed on each context; Each dimensionality reduced analyzed context is input into the computer as a separate earth model to train a machine learning system to determine a relationship between the dimensionality reduced context and the physical property. In the computer, the trained machine learning system is used to estimate the physical property at each spatial location and at each time.

A computer program according to another aspect of this disclosure is stored in a non-transitory computer readable medium. The program has logic operable to cause a programmable computer to perform actions. The actions comprise generating a discretized model of the subsurface formation in space and time. The discretized model comprises at least one physical parameter of the subsurface formation and a relationship between the at least one physical parameter and the physical property. For each spatial location and at each time in the discretized model, a time independent solution to the relationship is calculated. In the computer, a context is defined of a selected number of grid cells surrounding each spatial location. Dimensionality reduction is performed on each context. Each principal dimensionality reduced context is input into the computer as a separate earth model to train a machine learning system to determine a relationship between the dimensionality reduced context and the physical property. The trained machine learning system is used to estimate the physical property at each spatial location and at each time.

In some embodiments, the time independent solution comprises solution to a Poisson equation.

In some embodiments, the at least one physical property comprises formation fluid pressure.

In some embodiments, the at least one physical parameter comprises formation porosity and corresponding permeability.

In some embodiments, the at least one physical parameter is obtained using measurements made of subsurface formations.

In some embodiments, the measurements comprise at least one of well log measurements, surface reflection seismic surveys and measurements made on samples of the subsurface formation.

In some embodiments, the dimensionality reduction comprises principal component analysis.

Other aspects and possible advantages will be apparent from the description and claims that follow.

### BRIEF DESCRIPTION OF THE DRAWINGS

FIG. 1 shows a flow chart of an example process according to this disclosure.

FIG. 2 shows a graphic explanation of context around individual grid cells in an earth model.

FIG. 3 shows an example computer system that may be used in some embodiments.

### DETAILED DESCRIPTION

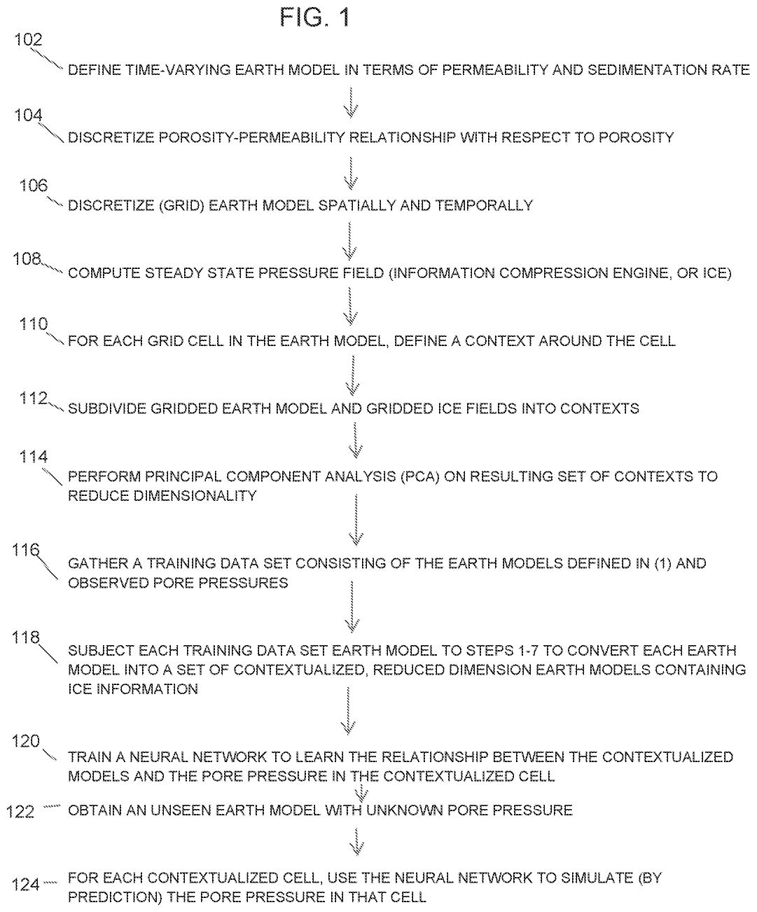

FIG. 1 shows a flow chart of an example embodiment of a method according to the present disclosure. At 102, a model of a geologic structure, referred to herein as an “earth model”, may be defined. The geologic structure may be partially or totally below the surface or below the bottom of a body of water. The earth model may be a three dimensional (3D) representation of geologic formations. Such geologic formations may be defined, with reference to spatial position within the earth model, by formation mineral composition and grain structure (facies), and the physical properties of such formation that uniquely characterize each formation with respect to the phenomenon or physical parameter to be simulated or estimated. For simulating or estimating fluid pressure in the pore spaces of porous and permeable rock formation (referred to as pore pressure simulation), the rate of accumulation of sediment, and a relationship between fractional volume of pore space (porosity) in the formation with respect to fluid permeability have been shown to be sufficient to uniquely characterize each formation. Rate of accumulation of sediment may be estimated, for example, by relating the depth of the relevant grid cell in the earth model to the value of time at each time increment. Parameter values for the earth model may be obtained from measurements of actual formation properties, for example, well log measurements made in wells drilled through formations in a specific geographic area. Such measurements may comprise, without limitation, natural gamma radiation, electrical resistivity, density, acoustic velocity and neutron porosity, among others. Other measurements may comprise laboratory analysis of samples of earth formations obtained from, for example, surface outcrops and well core plugs. Structure (spatial distribution) of the formations may be inferred, for example, from surface reflection seismic surveys made on the same geographic area. It is also known to use relationships between attributes, e.g., instantaneous phase, instantaneous spectrum and/or attenuation, of reflection seismic survey data and certain physical parameters of the formations, which may be calibrated with reference to actual parameter measurements, to infer values of the parameters in areas distant from where well log or other physical measurements had been made. The earth model, as explained above, may at each spatial location comprise a rate of accumulation of additional sediment, such that at each spatial position in the 3D representation, a depth in the subsurface and thickness of any formation layer may change with respect to time, depending on the local sediment accumulation rate and physical properties of the accumulating sediments and the underlying facies.

At 104, where any one or more geological parameters are defined by a determinable relationship between such parameters and any other quantities, the earth model may be updated to include a discretized representation (i.e., cell by cell discrete values) of that relationship, as input to the artificial intelligence-based simulation technique described below. For example, in pore pressure simulation, the relationships of fluid permeability with reference to porosity may be discretized in this manner, that is, by defining the relationship with respect to discrete values of porosity and permeability on a cell by cell basis.

In the present example embodiment, where pore pressure is a parameter to be simulated or estimated, geologic formations are known to exhibit, for any specific facies, a determinable relationship between porosity and permeability. A determined relationship for any facies may be represented by a subset of porosity values in the domain of all porosity values of the facies within the earth model, and for each of the values of formation porosity in the subset, a permeability value may be associated with the porosity. Such representation may be referred to as discretizing the porosity-permeability relationship.

At 106, the earth model may be, to the extent not already performed, discretized (arranged into discrete values) within grid cells in both 3D spatial coordinates (represented by total numbers, M×N×K of grid cells) and in time (a number T of time steps). Thus, the earth model may be discretized into a plurality of 3D, cell by cell representations of spatial distribution of facies and the geological parameters used as inputs to the modeling. Each of such 3D spatial representations may be associated with a specific point in time, yielding a total of M×N×K×T grid cells, each of which is described geologically by a chosen number, P, of physical parameters of the formations in the earth model.

At 108, for each grid cell in the 3D representation, and for each time associated with the plurality of time points t, and for one of a subset (of size P) of the geological parameters p, a field g is calculated. The field g in the present example embodiment may be the solution to a Poisson equation parameterized by the spatially varying geological parameter(s) p at each time t. Where required, the source term in the Poisson equation may be one of the geological parameters p. In the present example embodiment, where the modeled or estimated parameter is pore pressure, the Poisson equation may be parameterized by the permeability at a fixed porosity (defined in the parameter discretization stage described above) with sedimentation rate as the source term in the Poisson equation. The Poisson equation may be a simplified representation of the governing equation that is time independent, when time varying terms in the equation are negligible. Therefore, the Poisson field g may also be referred to as a steady-state solution. Because the time independent solution encodes information about the entire permeability model into the solution at each cell, the Poisson field g may also be referred to as an “information compression engine” (ICE). The calculation may be performed, for example, by the finite volume method. The steady-state solution at each cell becomes an additional input parameter to the simulation, such that there are M×N×K×P×2 total parameters in the simulation at each of a number T of time steps. The designation of calculating the Poisson field as the Information Compression Engine is because the Poisson solution is affected by the entire earth model, even when examining the earth model in the local contexts below. While the ICE is an approximate solution to the earth model problem, the reason that the ICE compresses information is because each cell is now informed about all the other cells in the earth model with reference to how the physical parameters in those cells relate to each other. This is also approximately equivalent to the steady-state solution of the problem, at very late time, which comprises information about the entire model.

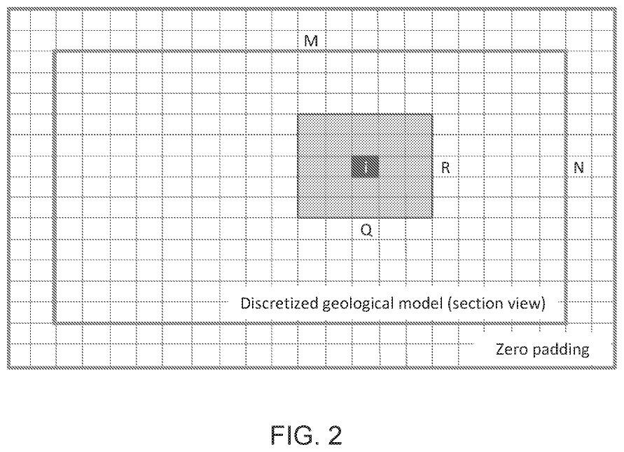

At 110, for each grid cell in the earth model, a “context” may be defined around the grid cell. Thus, for each grid cell in the discretized earth model, a selection of neighboring grid cells may be defined (there may be “zero padding”, i.e., all cell values set to zero, applied on the borders of the model). Defining context brings information about local shape (i.e., the spatial distribution) of the modeled parameter (e.g., permeability) field and the associated parameter (e.g., pore pressure) field. The context definition effectively breaks a single M×N×K×P×2 grid cell dimension earth model into a number, M×N×K×P×2, of individual earth models, each such earth model having a defined set of context cells surrounding each “output” cell, thereby increasing the effective data available to train a machine learning system such as a neural network, as further described below. The context may be defined as a 3D “box” around each output grid cell; thus the context will have dimensions Q×R×S. Context is illustrated graphically in FIG. 2.

Returning to FIG. 1, at 112, the entire earth model may be subdivided into the foregoing contexts surrounding each output cell. At 114, dimensionality reduction may be performed. In the present example embodiment principal component analysis (PCA) may be performed on the resulting set of contexts to reduce dimensionality. In the present example embodiments, at each time point and for each cell, the earth model in the data set is Q×R×S×P×2 grid samples in size. The process ties the foregoing parameters to the simulated quantity (e.g., fluid pressure) in the respective grid cell at the center of the relevant context. A mapping function (i.e., from input parameter values to simulated quantity) has Q×R×S×P×2 parameters. Such a large number of parameters could result in excessive computation time using large data sets. In a method according to the present disclosure, the dimensionality of the parameters may be reduced by subjecting the high dimension data to principal components analysis (PCA).

PCA is a dimensionality-reduction method that is used to reduce the number of parameters in large data sets, by transforming a large set of parameters (variables) into a smaller set or parameters that still contains most of the information present in the large set. Reducing the number of parameters in a data set reduces accuracy of the representation of the physical domain made by the data set; the tradeoff is a giving up a relatively small amount of accuracy in exchange for a relatively large reduction in the number of parameters. Smaller data sets facilitate analyzing data and can provide faster machine learning by reducing the number of variables to process.

PCA may be characterized as follows. Step 1 in PCA is standardization. The purpose of standardization is to standardize the range of the continuous initial variables so that each one of them contributes equally to the analysis. More specifically, PCA is quite sensitive with respect to the variances of the initial variables. That is, if there are large differences between the ranges of the initial variables, those initial variables with larger ranges will dominate over those with small ranges. Mathematically, standardization can be performed by subtracting the mean and dividing by the standard deviation for each value of each variable. Once the standardization is performed, all the variables may be transformed to the same scale.

Step 2 in PCA is covariance matrix computation. The objective of the covariance matrix computation is to understand how the variables of the input data set vary from the mean with respect to each other, that is, to determine if there is any relationship between them. The foregoing is relevant because sometimes variables are highly correlated with each other, such that they contain functionally redundant information. So, in order to identify the existence of such correlations, the covariance matrix is computed. The covariance matrix is a D×D symmetric matrix (where D is the number of dimensions) that has as entries the covariances associated with all possible pairs of the initial set of variables.

Step 3 in PCA is to compute the eigenvectors and eigenvalues of the covariance matrix to identify the principal components. Principal components are introduced variables that are constructed as combinations of the initial variables. These combinations are performed in such a way that the new variables (i.e., the principal components) are uncorrelated and most of the information within the initial variables is compressed into the first few principal components. Organizing information into principal components enables reducing dimensionality without losing substantial information, and thus by discarding the components with low information and considering only the remaining components as having substantive information. Following PCA, each contextualized data set has been reduced from Q×R×S×P×2 dimensions to D dimensions.

At 116, a training data set is compiled for implementation on a machine learning system, for example, a neural network. The training data set may comprise each of the earth models originally defined at 100, and at 118, and each such earth model may be processed as explained with reference to 104 through 114 in FIG. 1.

At 120, the machine learning system, e.g., a neural network, may be trained to learn the relationship between the contextualized earth models and the simulated quantity (e.g., pore fluid pressure) in each cell in each of the time-based 3D spatial representations. The machine learning, e.g., neural network, design used in an example implementation may be simple, for example and without limitation, a two-layer fully-connected dense neural network, with roughly 2×S nodes in the first layer, and 4×S nodes in the second layer. However, the neural network design can be changed as needed. The neural network here mimics partial differential operators in the governing equations in a way that is faster and more flexible than known numerical solutions. Unlike numerical approaches, the solution according to the present disclosure may additionally be obtained at a subset of the total model cells, made possible by the introduction of whole-model information at each cell via the information compression in the time independent solution.

At 122, a new earth model may be entered as input to the trained neural network. The earth model may comprise some or all of the same the input parameters of the earth models used to train the neural network. The new earth model represents spatial distribution of geologic formations for which the simulated quantity (for which the neural network has been previously trained) at any selected point in the model is to be determined using the trained neural network. Each cell in the new earth model may be contextualized and processed by PCA (to reduce dimensionality) as explained with reference to steps 110 through 114.

The new earth model, thus contextualized, and reduced in dimensionality may then be used as input to the trained neural network, and at 124, the trained neural network may calculate an expected physical parameter (such as pore fluid pressure) at each cell in the 3D grid at any one or more selected time points.

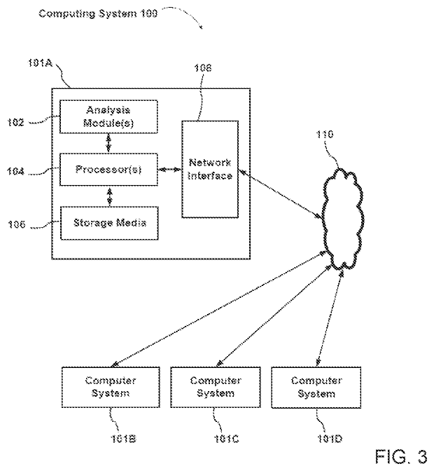

FIG. 3 shows an example computing system 100 in accordance with some embodiments. The computing system 100 may be an individual computer system 101A or an arrangement of distributed computer systems. The individual computer system 101A may include one or more analysis modules 102 that may be configured to perform various tasks according to some embodiments, such as the tasks explained with reference to FIG. 3. To perform these various tasks, the analysis module 102 may operate independently or in coordination with one or more processors 104, which may be connected to one or more storage media 106. A display device 105 such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor may include, without limitation, a microprocessor, microcontroller, processor module or subsystem, programmable integrated circuit, programmable gate array, or another control or computing device.

The storage media 106 may be implemented as one or more computer-readable or machine-readable storage media. Note that while in the example embodiment of FIG. 3 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 3, and/or the computing system 100 may have a different configuration or arrangement of the components shown in FIG. 3. The various components shown in FIG. 3 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for simulating a physical property of a subsurface formation, comprising:
in a programmable computer, generating a discretized model of the subsurface formation in space and time, the discretized model comprising at least one physical parameter of the subsurface formation and a relationship between the at least one physical parameter and the physical property;
in the computer, calculating, for each spatial location and at each time in the discretized model, a time independent solution to the relationship;
in the computer, defining a context of a selected number of grid cells surrounding each spatial location;
in the computer, performing dimensionality reduction on each context;
inputting, into the computer, each dimensionality reduced context as a separate earth model to train a machine learning system to determine a relationship between the dimensionality reduced context and the physical property; and
in the computer, using the trained machine learning system to estimate the physical property at each spatial location and at each time.

2. The method of claim 1 wherein the time independent solution comprises solution to a Poisson equation.

3. The method of claim 1 wherein the at least one physical property comprises formation fluid pressure.

4. The method of claim 1 wherein the at least one physical parameter comprises formation porosity and corresponding permeability.

5. The method of claim 1 wherein the at least one physical parameter is obtained using measurements made of subsurface formations.

6. The method of claim 5 wherein the measurements comprise at least one of well log measurements, surface reflection seismic surveys and measurements made on samples of the subsurface formation.

7. The method of claim 1 wherein the dimensionality reduction comprises principal component analysis.

8. A computer program stored in a non-transitory computer readable medium, the program having logic operable to cause a programmable computer to perform actions, comprising:
generating a discretized model of the subsurface formation in space and time, the discretized model comprising at least one physical parameter of the subsurface formation and a relationship between the at least one physical parameter and the physical property;
calculating, for each spatial location and at each time in the discretized model, a time independent solution to the relationship;
defining a context of a selected number of grid cells surrounding each spatial location;
performing dimensionality reduction on each context;
inputting each dimensionality reduced context as a separate earth model to train a machine learning system to determine a relationship between the dimensionality reduced context and the physical property; and
using the trained machine learning system to estimate the physical property at each spatial location and at each time

9. The computer program of claim 8 wherein the time independent solution comprises solution to a Poisson equation.

10. The computer program of claim 8 wherein the at least one physical property comprises formation fluid pressure.

11. The computer program of claim 8 wherein the at least one physical parameter comprises formation porosity and corresponding permeability.

12. The computer program of claim 8 wherein the at least one physical parameter is obtained using measurements made of subsurface formations.

13. The computer program of claim 8 wherein the measurements comprise at least one of well log measurements, surface reflection seismic surveys and measurements made on samples of the subsurface formation.

14. The computer program of claim 8 wherein the dimensionality reduction comprises principal component analysis.
